(19) United States
(12) Patent Application Publication
(10) Pub. No.: US 2026/0051799 A1
(43) Pub. Date: Feb. 19, 2026

(54) ELECTRIC MOTOR WITH STAKED RESOLVER STATOR

(71) Applicant: Schaeffler Technologies AG & Co. KG, Herzogenaurach (DE)

(72) Inventor: Matthew Payne, Glenmont, OH (US)

(21) Appl. No.: 18/808,920

(22) Filed: Aug. 19, 2024

(51) Int. Cl. H02K 24/00; H02K 11/225

(52) U.S. Cl. CPC H02K 24/00; H02K 11/225

(57) ABSTRACT

An electric motor assembly including a housing having an internal surface including an annular array of positioning features including at least one deformable stake extending in an axial direction, and a resolver stator configured to be mounted within the housing and including a corresponding annular array of radially extending alignment features, wherein each deformable stake is configured to be deformed into contact with one of the radially extending alignment features to constrain motion of the resolver stator relative to the housing. Assemblies including corresponding alignment and retention features for maintaining positional relationships between mounted components without the need for separate fasteners.

### TECHNICAL FIELD

The present disclosure generally relates to electric motor assemblies, and, more particularly, to an electric motor including a staked resolver stator.

### BACKGROUND

Electric motors are complex assemblies that include both static and dynamic components. A particular static component is the resolver stator. In use, the resolver stator provides a fixed reference for determining an angular position of the corresponding resolver rotor. Traditional electric motors mount the resolver stator within the housing using fasteners (e.g., threaded bolts) received in machined openings. Separate fasteners add weight, manufacturing complexity and cost to electric motor assemblies. In addition, separate fasteners require precise torquing. Therefore, what is needed is a solution for mounting static components, such as the resolver stator, in an electric motor assembly without using separate fasteners.

### SUMMARY

An electric motor assembly is described, in accordance with one or more embodiments of the present disclosure. In some embodiments, the electric motor assembly includes a housing having an internal surface including an annular array of positioning features each including at least one deformable stake extending in an axial direction of the electric motor assembly, and a resolver stator configured to be mounted within the housing and including an annular array of radially extending alignment features for alignment with the annular array of positioning features. In use, each deformable stake is configured to be deformed into contact with one of the radially extending alignment features to constrain motion of the resolver stator relative to the housing.

In some aspects, the positioning features are positioning castles and the alignment features extend radially outward and are received in the respective positioning castles.

In some aspects, the at least one deformable stake includes a radial stake positioned proximal to a radial end of the respective positioning features, and the radial stake is configured to be deformed radially inward to constrain radial motion of the resolver stator relative to the housing.

In some aspects, the at least one deformable stake includes a lateral stake positioned proximal to a lateral side of the respective positioning features, and the lateral stake is configured to be deformed laterally inward to constrain rotational motion of the resolver stator relative to the housing.

In some aspects, the at least one deformable stake includes a radial stake and at least one lateral stake, wherein the radial stake is positioned proximal to a radial end of the respective positioning feature and is configured to be deformed radially inward to constrain radial motion of the resolver stator relative to the housing, and the at least one lateral stake is positioned to a lateral side of the respective positioning feature and is configured to be deformed laterally inward to constrain rotational motion of the resolver stator relative to the housing.

In some aspects, the at least one deformable stake includes a radially inwardly extending portion configured to overlay a portion of the resolver stator to constrain axial motion of the resolver stator.

In some aspects, the positioning features and the radially extending alignment features correspond in number.

In some aspects, the positioning features are spaced equidistant and the radially extending alignment features are spaced equidistant.

In some aspects, the electric motor assembly further includes an axially extending cavity formed in each of the positioning features, an axially extending opening formed through each of the radially extending alignment features, and an axially extending alignment dowel pin received through each axially extending opening and corresponding axially extending cavity.

An electric motor assembly is described, in accordance with one or more embodiments of the present disclosure. In embodiments, the electric motor assembly includes a first component including an array of positioning features each including at least one deformable stake, and a second component configured to be mounted to the first component, the second component including an array of alignment features corresponding in number and position to the positioning features, wherein each deformable stake is configured to be deformed into contact with one of the alignment features to maintain a predefined alignment between the first and second components.

In some aspects, the predefined alignment is an angular alignment.

In some aspects, the array of positioning features is an annular array, and the array of alignment features is an annular array.

In some aspects, the at least one deformable stake includes a radial stake positioned proximal to a radial end of the respective positioning feature, and wherein the radial stake is configured to be deformed radially inward to constrain radial motion of the second component relative to the first component.

In some aspects, the at least one deformable stake includes a lateral stake positioned proximal to a lateral side of the respective positioning feature, wherein the lateral stake is configured to be deformed laterally inward to constrain rotational motion of the second component relative to the first component.

In some aspects, the at least one deformable stake includes a radial stake and at least one lateral stake, wherein the radial stake is positioned proximal to a radial end of the respective positioning feature and is configured to be deformed radially inward to constrain radial motion of the second component relative to the first component, and the at least one lateral stake is positioned to a lateral side of the respective positioning feature and is configured to be deformed laterally inward to constrain rotational motion of the second component relative to the first component.

In some aspects, the at least one deformable stake includes a radially inwardly extending portion configured to overlay a portion of the second component when installed to constrain axial motion of the second component.

In some aspects, the positioning features are spaced equidistant, and the alignment features are spaced equidistant.

In some aspects, the first component is a housing and the second component is a resolver stator configured to be mounted to the housing.

An assembly is described, in accordance with one or more embodiments of the present disclosure. In embodiments, the assembly includes a first component including a plurality of first positioning features, each first positioning feature including at least one deformable stake, and a second component configured to be mounted to the first component, the second component including a plurality of second positioning features, corresponding in number to the first positioning features, configured to engage the first positioning features. In use, each deformable stake is configured to be deformed into contact with a respective one of the alignment features to constrain relative motion between the first and second components.

In some aspects, each deformable stake includes an axially extending portion terminating in a laterally extending portion.

### BRIEF DESCRIPTION OF THE DRAWINGS

The numerous advantages of the disclosure may be better understood by those skilled in the art by reference to the accompanying figures in which:

FIG. 1 depicts a fragmentary axial view of an electric motor assembly, in accordance with one or more embodiments of the present disclosure;

FIG. 2 depicts a detailed view of FIG. 1, in accordance with one or more embodiments of the present disclosure; and

FIG. 3 depicts a cross-section view of FIG. 2 taken along line A-A, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed generally to component mounting solutions that obviate the need for separate mounting fasteners. In a particular conceived example, a resolver stator is statically mounted to a housing using a plurality of stakes configured to be deformed into contact with alignment features formed on the resolver stator to maintain a fixed position (e.g., angular alignment) of the resolver stator relative to the housing. The housing and the resolver stator may include a corresponding number of alignment features configured to radially align (e.g., center) the resolver stator relative to the housing. The mounting solutions described herein are not limited to resolver stator mounting and electric motor assemblies, but instead find widespread application to any assembly that benefits from an integrated component mounting solution that reduces cost, weight, and manufacturing complexity, among other benefits and advantages.

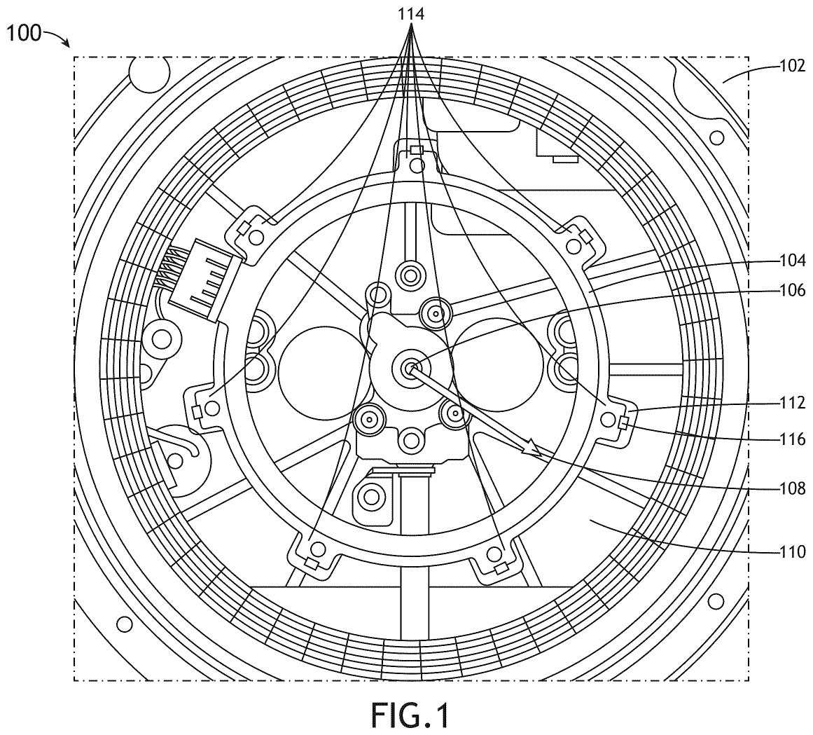

FIG. 1 depicts a non-limiting example of an electric motor assembly 100. The electric motor assembly 100 as shown includes a housing 102 and a resolver stator 104 mounted in the housing 102. It is understood that the electric motor assembly 100 includes additional components not critical or limiting to the present disclosure.

In embodiments, the housing 102 defines an interior space, for instance a generally cylindrical interior space, for receiving the resolver stator 104 and additional components such as the rotor, stator, windings, revolving shaft, resolver rotor, etc. The axis of the revolving components of the electric motor assembly 100 indicating the axial direction is shown at reference numeral 106, and a radial direction originating and extending perpendicularly from the axis 106 is shown at reference numeral 108. The terms “axial” and “radial” as used herein are intended to have their ordinary meanings and are used as reference directions to explain relative positions of the components described herein.

As shown, the housing 100 includes an internal housing surface 110 that may correspond to an internal end wall of the housing 100. The internal housing surface 110 includes a plurality of positioning features 112 configured to mount the resolver stator 104 in a predefined angular orientation (e.g., clocking) relative to the housing 100. In some embodiments, the positioning features 112 are positioning castles formed by housing portions that extend in the axial direction 106. Alternative configurations of the positioning features may include, but are not limited to, raised flanges, interdigitating features, grooves, recesses, etc. In some embodiments, the positioning features 112 may be arranged in an annular array and may be spaced equidistant. As shown, the housing 102 includes seven positioning features 112 arranged in an annular array and spaced equidistant; however, in alternative embodiments the housing 102 may include two, three, four . . . n number of positioning features 112 in different arrays and spacing arrangements. One of the positioning features 112 may be positioned at the 12 O'clock position to provide a fixed reference.

The resolver stator 104 includes alignment features 114 that correspond in number and position to the number and position of the positioning features 112. Thus, in the non-limiting example shown, the resolver stator 104 includes seven alignment features 114 that are also arranged in an annular array and are spaced equidistant. In some embodiments, the alignment features 114 are radially extending ears each configured to be positioned relative to (e.g., within) one of the positioning castles. When installed in the housing 102, the resolver stator 104 is mounted such that each alignment feature 114 is aligned and positioned relative to one of the positioning features 112, thus forming seven corresponding pairs of features.

Each positioning feature 112 includes at least one deformable stake 116 for staking the resolver stator 104 to constrain motion of the resolver stator 104 relative to the housing 102, for instance to prevent axial motion and to center the resolver stator 104 relative to the axis 106 about which the shaft (not shown) revolves. In use, each deformable stake 116 may be integrally formed with the respective positioning feature 112, which in turn may be integrally formed with the housing 102. In some embodiments, the housing 102 may be made from aluminum.

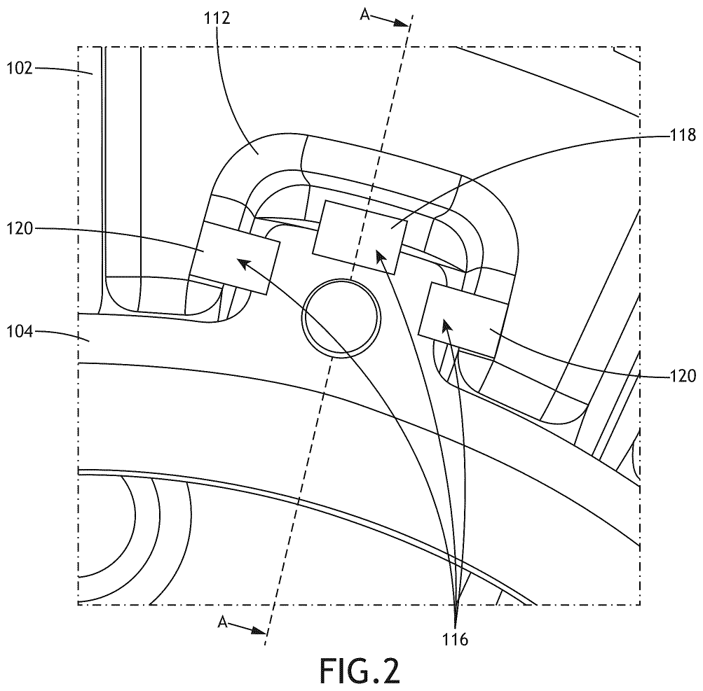

FIG. 2 depicts configurations of stakes 116 for constraining motion of the resolver stator 104 to fix the angular position of the resolver stator 104 relative to the housing 102. In some embodiments, each positioning feature 112 includes at least one radial stake 118 positioned proximal to a radial end of the respective positioning feature 112. In use, the radial stake 118 is configured to be deformed radially inward to constrain radial motion of the resolver stator 104 relative to the housing 102. In some embodiments, each positioning feature 112 includes at least one lateral stake 120 positioned proximal to a lateral side of the respective positioning feature 112. In use, each lateral stake 120 is configured to be deformed laterally inward to constrain rotational motion of the resolver stator 104 relative to the housing 102. In some embodiments, each positioning feature 112 may include at least one radial stake 118 and at least one lateral stake 102, where space and access in the housing 102 permits the use of both types.

Portions of the stakes 116 may extend coaxially with the alignment features 114 while further portions of the stakes 116 may extend laterally to overlay portions of the alignment features 114. In this configuration, the stakes 116 constrain both axial and rotational motion of the resolver stator 104.

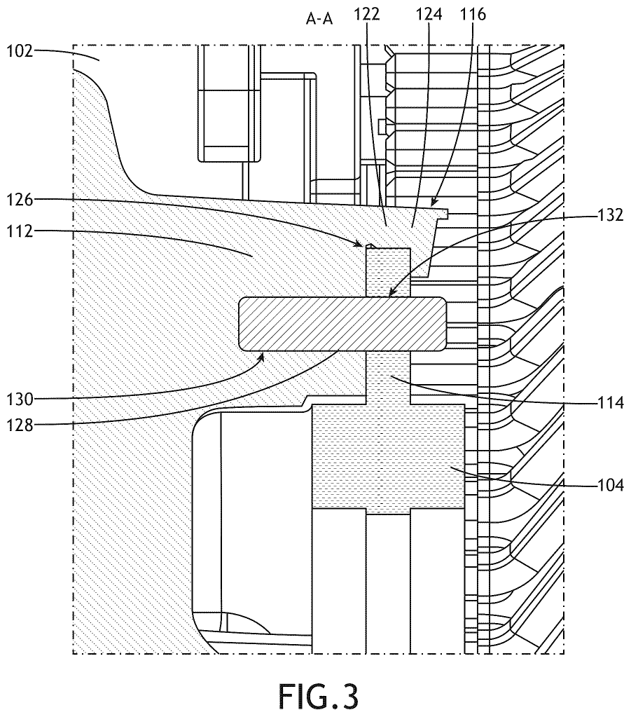

FIG. 3 depicts a cross-section view of FIG. 2 taken along line A-A. In embodiments, each alignment feature 114 (e.g., radially extending ear) of the resolver stator 104 is positioned within a respective positioning feature (e.g., positioning castle) and in physical contact with the housing 102. In embodiments, portions of the resolver stator 104 may sit ‘atop’ portions of the housing 102.

In embodiments, each stake 116 may include a first portion 122 that extends axially, and a second portion 124 that extends radially to overlay the alignment feature 114. In some embodiments, the first and second portions 122, 124 may be integrally formed and the second portion 124 may be positioned at the terminal end of the first portion 122. Each stake 116 may further include a material void 126 positioned at the interface of the attached end of the first portion 122 for facilitating deformation (e.g., bending) while minimizing the risk of fracture. In use, each stake 116 may be manufactured with an outward radial bias, and after resolver stator 102 placement, may be deformed radially inward into contact with the resolver stator 104, and more specifically the alignment feature 114 of the resolver stator 104.

In some embodiments, the resolver stator 104 may be further aligned with the housing 102 using dowel pins 128. A cavity 130 may be formed in each positioning feature 112, and a corresponding opening 132 may be formed in each respective alignment feature 114. In use, the openings 132 may be aligned with the cavities 130 and the dowel pins 128 inserted in the axial direction to maintain angular alignment of the resolver stator 104. In an alternative embodiment, pins may be mounted to or integrally formed with the resolver stator 104, wherein the pins are received in the corresponding cavities 130 formed in the positioning features 112.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” “downward,” “outward,” “inward,” etc. are intended to provide relative positions for purposes of description and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 Electric motor assembly
102 Housing
104 Resolver stator
106 Axial direction
108 Radial direction
110 Internal housing surface
112 Positioning features
114 Alignment features
116 Stakes
118 Radial stake
120 Lateral stake
122 Stake first portion
124 Stake second portion
126 Material void
128 Dowel pin
130 Cavity
132 Opening

What is claimed:

1. An electric motor assembly, comprising:
a housing having an internal surface including an annular array of positioning features, each positioning feature including at least one deformable stake extending in an axial direction of the electric motor assembly; and
a resolver stator configured to be mounted within the housing, the resolver stator including an annular array of radially extending alignment features for alignment with the annular array of positioning features;
wherein each deformable stake is configured to be deformed into contact with one of the radially extending alignment features to constrain motion of the resolver stator relative to the housing.

2. The electric motor assembly of claim 1, wherein the positioning features are positioning castles and the alignment features extend radially outward and are received in the respective positioning castles.

3. The electric motor assembly of claim 1, wherein the at least one deformable stake includes a radial stake positioned proximal to a radial end of the respective positioning feature, and wherein the radial stake is configured to be deformed radially inward to constrain radial motion of the resolver stator relative to the housing.

4. The electric motor assembly of claim 1, wherein the at least one deformable stake includes a lateral stake positioned proximal to a lateral side of the respective positioning feature, and wherein the lateral stake is configured to be deformed laterally inward to constrain rotational motion of the resolver stator relative to the housing.

5. The electric motor assembly of claim 1, wherein the at least one deformable stake includes a radial stake and at least one lateral stake, wherein the radial stake is positioned proximal to a radial end of the respective positioning feature and is configured to be deformed radially inward to constrain radial motion of the resolver stator relative to the housing, and the at least one lateral stake is positioned to a lateral side of the respective positioning feature and is configured to be deformed laterally inward to constrain rotational motion of the resolver stator relative to the housing.

6. The electric motor assembly of claim 1, wherein the at least one deformable stake includes a radially inwardly extending portion configured to overlay a portion of the resolver stator to constrain axial motion of the resolver stator.

7. The electric motor assembly of claim 1, wherein the positioning features and the radially extending alignment features correspond in number.

8. The electric motor assembly of claim 1, wherein the positioning features are spaced equidistant, and wherein the radially extending alignment features are spaced equidistant.

9. The electric motor assembly of claim 1, further comprising:
an axially extending cavity formed in each of the positioning features;
an axially extending opening formed through each of the radially extending alignment features; and
an axially extending alignment dowel pin received through each axially extending opening and corresponding axially extending cavity.

10. An electric motor assembly, comprising:
a first component including an array of positioning features, each positioning feature including at least one deformable stake; and
a second component configured to be mounted to the first component, the second component including an array of alignment features corresponding in number and position to the positioning features;
wherein each deformable stake is configured to be deformed into contact with one of the alignment features to maintain a predefined alignment between the first and second components.

11. The electric motor assembly of claim 10, wherein the predefined alignment is an angular alignment.

12. The electric motor assembly of claim 10, wherein the array of positioning features is an annular array, and the array of alignment features is an annular array.

13. The electric motor assembly of claim 12, wherein the at least one deformable stake includes a radial stake positioned proximal to a radial end of the respective positioning feature, and wherein the radial stake is configured to be deformed radially inward to constrain radial motion of the second component relative to the first component.

14. The electric motor assembly of claim 12, wherein the at least one deformable stake includes a lateral stake positioned proximal to a lateral side of the respective positioning feature, wherein the lateral stake is configured to be deformed laterally inward to constrain rotational motion of the second component relative to the first component.

15. The electric motor assembly of claim 12, wherein the at least one deformable stake includes a radial stake and at least one lateral stake, wherein the radial stake is positioned proximal to a radial end of the respective positioning feature and is configured to be deformed radially inward to constrain radial motion of the second component relative to the first component, and the at least one lateral stake is positioned to a lateral side of the respective positioning feature and is configured to be deformed laterally inward to constrain rotational motion of the second component relative to the first component.

16. The electric motor assembly of claim 12, wherein the at least one deformable stake includes a radially inwardly extending portion configured to overlay a portion of the second component when installed to constrain axial motion of the second component.

17. The electric motor assembly of claim 10, wherein the positioning features are spaced equidistant, and the alignment features are spaced equidistant.

18. The electric motor assembly of claim 10, wherein the first component is a housing and the second component is a resolver stator configured to be mounted to the housing.

19. An assembly, comprising:
a first component including a plurality of first positioning features, each first positioning feature including at least one deformable stake; and
a second component configured to be mounted to the first component, the second component including a plurality of second positioning features, corresponding in number to the first positioning features, configured to engage in the first positioning features;
wherein each deformable stake is configured to be deformed into contact with a respective one of the alignment features to constrain relative motion between the first and second components.

20. The assembly of claim 19, wherein each deformable stake includes an axially extending portion terminating in a laterally extending portion.
